(19) United States
(12) Patent Application Publication
(10) Pub. No.: US 2013/0302474 A1
(43) Pub. Date: Nov. 14, 2013

(54) MEAT PRODUCT WITH A WRAPPER AND METHODS FOR PRODUCTION

(71) Applicant: Oscar GARZA, Mission, TX (US)

(72) Inventor: Oscar GARZA, Mission, TX (US)

(21) Appl. No.: 13/466,452

(22) Filed: May 8, 2012

(51) Int. Cl. A23L 1/312; A23L 1/317; A23L 1/318; B65B 11/48

(52) U.S. Cl. 426/105; 53/461; 426/646

(57) ABSTRACT

A meat product taken from one or more animals includes a first wrapper of an extendable animal organ. The meat product further includes at least a first organ meat and a second organ meat. The first wrapper substantially surrounds the first and the second organ meats.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

### Background of the Technology

Animal meats and other tissues are commonly produced as products that may be used for human consumption or other purposes. These products include individual cuts of meat such as steaks, roasts, or ribs for example. Other products include tallow to form soap or candles and fat for lantern oil. The products also include ground meats and mixtures of meats and tissues, such as hamburgers or sausage paddies and links. In forming a sausage link or a hot dog, portions of meats and tissues that are ground and thoroughly mixed are injected or extruded into a tubular casing, possibly a single extension of cleaned intestine. The meats and tissues blend to form what arguably becomes a single component. So too, the thin casing and the meat generally blend in structure, visual, texture, and/or taste qualities with the product as a whole. Due to this blending, the distinct identity or character of individual components is masked or lost.

### BRIEF SUMMARY OF THE DISCLOSURE

These and other needs in the art are addressed in one embodiment by a meat product taken from one or more animals. In an embodiment, the meat product includes a first wrapper of an extendable animal organ. In addition, the meat product includes at least a first organ meat and a second organ meat. The first wrapper substantially surrounds the first and the second organ meats.

These and other needs in the art are addressed in another embodiment by a meat product taken from one or more animals. In an embodiment, the meat product includes a first wrapper comprising stomach lining. Further, the meat product includes a first organ meat comprising animal heart and a second organ meat comprising liver. Still further, the meat product includes a second wrapper comprising animal intestine. The first wrapper substantially surrounds the first organ meat and the second organ meat, and the second wrapper surrounds at least a portion of the first wrapper.

These and other needs in the art are addressed in another embodiment by a method for producing a meat product derived from animal. In an embodiment, the method includes extending a first wrapper on a surface and placing one or more portions of a first organ meat on or adjacent the first wrapper. In addition, the method includes placing one or more portions of a second organ meat on or adjacent the first wrapper, and adjusting the first wrapper to surround substantially the first organ meat and the second organ meat.

Thus, embodiments described herein comprise a combination of features and advantages intended to address various shortcomings associated with certain prior devices, systems, and methods. The various characteristics described above, as well as other features, will be readily apparent to person having ordinary skill in the art upon reading the following detailed description, and by referring to the accompanying drawings.

### BRIEF DESCRIPTION OF THE DRAWINGS

For a detailed description of the disclosed embodiment(s) of the invention, reference will now be made to the accompanying drawings in which:

FIG. 1 is perspective view of an embodiment of a meat product in accordance with the principles disclosed herein.

FIG. 2 is a top view of at least a portion of the meat product of FIG. 1 in accordance with the principles disclosed herein.

FIG. 3 is another top view of at least a portion of another embodiment of the meat product of FIG. 1 in accordance with the principles disclosed herein.

FIG. 4 is a third top view of at least a portion of the meat product of FIG. 1 in accordance with the principles disclosed herein; and

FIG. 5 is a perspective view of an embodiment of a meat product in accordance with the principles disclosed herein.

FIG. 6 is a flow chart of a method for assembling a meat product in accordance with the principles disclosed herein.

### DETAILED DESCRIPTION

The following discussion is directed to various embodiments of the invention. The embodiments disclosed should not be interpreted or otherwise used as limiting the scope of the disclosure, including the claims. In addition, one skilled in the art will understand that the following description has broad application, and the discussion of any embodiment is meant only to be exemplary of that embodiment, and not intended to suggest that the scope of the disclosure, including the claims, is limited to that embodiment.

Certain terms are used in the following description and in the claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form, and some details of conventional elements may not be shown in interest of clarity and conciseness. In addition, like or identical reference numerals may be used to identify common or similar elements. When multiple instances of similar or identical components occur in an embodiment, some instances of the component might not be identified with a reference numeral in the figures.

In the following discussion and in the claims, the terms “including” and “comprising” are used in an open-ended fashion, and thus should be interpreted to mean “including, but not limited to . . . .” Also, the term “couple” or “couples,” if used, is intended to mean either an indirect or direct connection. Thus, if a first device couples or is coupled to a second device, that connection may be through a direct connection, or through an indirect connection via other devices, components, and connections. In addition, as used herein, the terms “axial” and “axially” generally mean along or parallel to a given axis (e.g., central axis of a body), while the terms “radial” and “radially” generally mean perpendicular to the axis. For instance, an axial distance refers to a distance measured along or parallel to the axis, and a radial distance means a distance measured perpendicular to the axis.

Furthermore, in the following disclosure and in the claims, the following, additional definitions will be used:

The term animal refers to non-human mobile creatures. In this definition animals include, for example, mammals (having various types, for example, bovine, goat, pig, sheep, deer, elk, bear), reptiles (having various types, for example, alligators, lizards, snakes), fish (having various types, for example, trout, halibut, red shaper, mahi-mahi, and having a habitat in either fresh or salt water), and birds (having various types, for example, chicken, geese, turkeys, pheasants, quails, ostrich). Pigs refer broadly to male and female pigs, hogs, and boars. This entire definition includes both domesticated and wild animals and includes herbivores, carnivores, and omnivores.

An extendable material refers to a cohesive, generally solid substance that may be extended, stretched, straightened, or otherwise arranged in such a manner as to make it to be larger or to appear larger in at least one dimension than it previously was. A stomach lining, an intestine, solid or semi-solid fat, skin, and similar animal tissue are examples of extendable materials.

Meat refers to product primarily derived from animal flesh, including, muscle tissue, heart, and liver. The meat may be discrete (separate) or may be interconnected pieces that are generally solid. Pieces or portions of meat may be whole, sliced, cubed, diced, tenderized, or may comprise another appropriate configuration. The meat may include other constituents, including other animal tissue.

A portion of a meat or any substance is a quantity determined by any convenient measuring or estimating method. For example, a portion of meat may be distinguished or measured by weight, by volume, or by visual or tactile evaluation. As a further example, a single portion may comprise (a) one or more weighed or visually assessed pieces of a meat, (b) a part of a single piece of meat as compared to the whole piece, (b) a volumetric measurement of a meat (for example, one quarter cup, one cup, two quarts, 250 milliliters, or a liter), or (c) any convenient discrete or continuous measurement. Then, two portions may comprise roughly twice the quantity of a single portion using the same method of measurement or estimate.

The terms tissue and organ will refer interchangeably to any distinguishable portion of an animal, and, in at least some embodiments disclosed herein, the terms tissue and organ will refer to an edible portion of an animal. In some animals, tissues and organs will include: heart, liver, kidney, gizzard, lung, stomach, fat, intestine, brain, skin, cartilage, skeletal muscle, and the like.

A wrap, wrapper, or wrapping (noun) refers in one sense to a continuous piece of extendable material that may be folded, bent, or curled around itself and may also substantially surround or envelop one or more other objects. In a second sense of the term, a wrap, wrapper, or wrapping comprises multiple pieces of an extendable material that may be grouped together so as to surround or envelop substantially one or more inner objects. When positioned within the wrapper, the inner object or objects may be fully occluded by the wrapper or may be partially visible.

Similarly, the term “wrapped” is used as an adjective to describe a physical configuration in which an object or a group of objects is covered by at least some portion of itself or is covered by one or more other objects. The covering object, i.e. the wrapper, may be, for example, rolled, folded, bent, or curled. Consequently, the wrapped object may be substantially surrounded or enveloped by one or more wrappers. As stated, the wrapped object and the wrapper may be one and the same or may be different or distinct.

### Implementation of Disclosed Embodiments and Methods

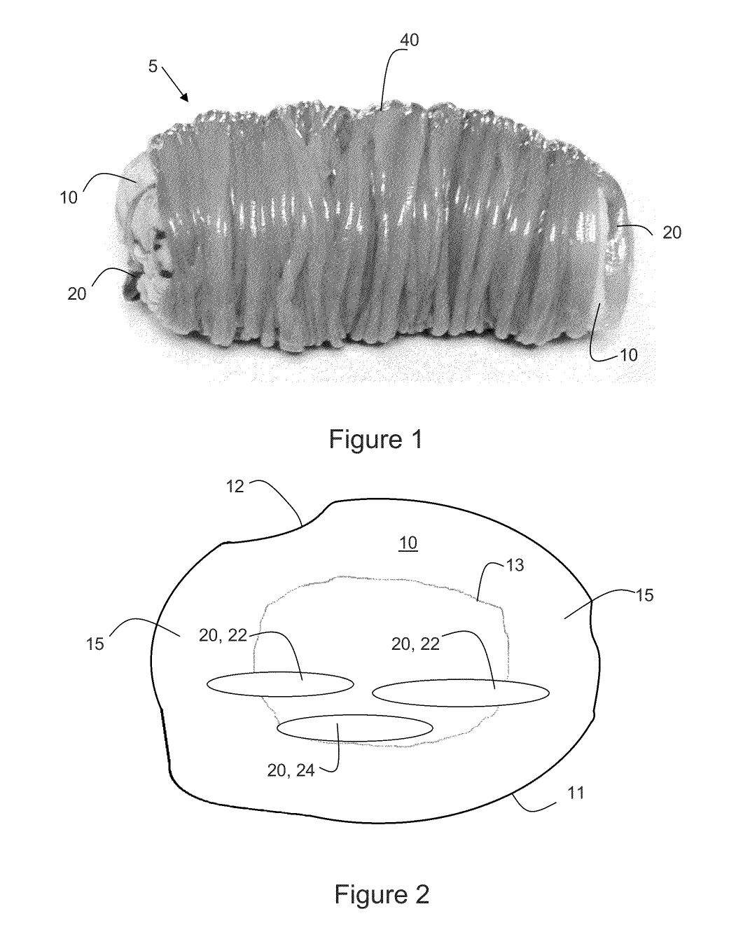

FIG. 1 illustrates a meat product, which in this example is a wrapped meat product 5. Meat product 5 comprises animal organ meat 20 substantially wrapped in or surrounded by at least one wrapper, such as first or inner wrapper 10. In some embodiments, a second or outer wrapper 40 may surround at least a portion of the first wrapper 10 and the organ meat 20.

Referring now to the assembly or configuration of a meat product exemplified in FIG. 2, the first wrapper 10 comprises extendable animal tissue or organ such as, for example, stomach or intestine and may be generally clear, translucent, or opaque. First wrapper 10 may include multiple layers such as, for example, mucosa lining, muscle, and fat. First wrapper 10 may comprise one or more portions from one or more animal organs (or equivalently, animal tissues).

The example of FIG. 2, presents a wrapper 10 that is longer in two dimensions and thinner in a third dimension (not shown), so that first wrapper 10 may be described as a sheet-like material. Viewed from the top, sheet-like wrapper 10 may have a generally rectangular or oval shape, or wrapper 10 may have any other convenient shape whether symmetrical or non-symmetrical. In other embodiments, the first wrapper may comprise multiple elongate pieces or strips of extendable animal organ. First wrapper 10 may be derived from one single animal, may be derived from two or more of a single type of animal, or may be derived from more than one type of animal. In embodiment, first wrapper 10 is derived from one or more goats.

On wrapper 10, a first edge 11 and second edge 12 can be defined. Edges 11, 12 are disposed opposite one another when wrapper 10 is extended on a generally flat surface. Two outer ends 15 extend between edges 11, 12. A generally defined central region 13 is disposed between edges 11, 12 and the two ends 15.

Continuing to reference FIG. 2, one or more portions of animal organ meat 20 are disposed on or adjacent the extended first wrapper 10. The example of FIG. 2 shows three portions of organ meat 20 disposed directly on top of wrapper 10. In general, the arrangement of organ meat 20 may or may not be uniform or symmetric. In at least one embodiment the arrangement of organ meat 20 will be non-uniform or random. Portions of organ meat 20 may be disposed on or adjacent central region 13. Organ meat 20 may extend beyond one or more edges 11, 12 and ends 15, which are the boundaries of wrapper 10.

Preferably, organ meat 20 includes at least a first organ meat 22 and a second organ meat 24. In at least one embodiment, the first organ meat 22 is derived substantially from animal heart. In at least one embodiment, the second organ meat 24 is derived substantially from animal liver. At least one embodiment comprises a single organ meat 20, which may be equivalent to organ meat 22 or organ meat 24. The one or more portions of meats 20, 22, 24 may be derived from one single animal, may be derived from two or more of a single type of animal, or may be derived from more than one type of animal. This statement includes the possibility that within a single meat product, for example meat product 5, the first organ meat 22 may include portions derived from different types of animal (for example, heart of bovine and heart pig). Similarly, the second organ meat 24 may include portions derived from different types of animal. Therefore, the meat product may be derived from a variety of animals. In one embodiment, meats 20, 22, 24 are derived from one or more goats.

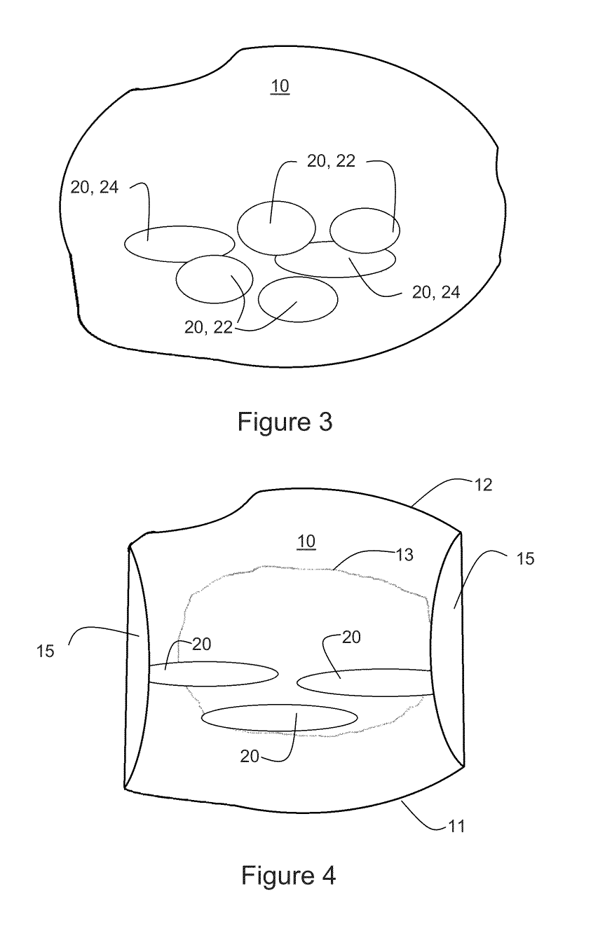

The example of FIG. 2 demonstrates that two portions or quantities of meat 20 may be a first organ meat 22, and one portion or quantity of meat 20 may be a second organ meat 24, both disposed on first wrapper 10. This combination of portions may be described by the ratio of 2:1, which may be read as the “ratio of two to one.” FIG. 3 offers another example of the 2:1 ratio by displaying four portions of meat 22 and two portions of meat 24. Other ratios defining different relative quantities of the two organ meats 22, 24 may be used, such as the ratios of 1:1, 1:2, 3:1, 1:3, 5:2, and 2:5 for example.

Any portion of a meat 20, 22, 24 may be whole, sliced, cubed, diced, tenderized, or may comprise another appropriate configuration. Any portion of a meat 20, 22, 24 may include seasonings and/or a marinade.

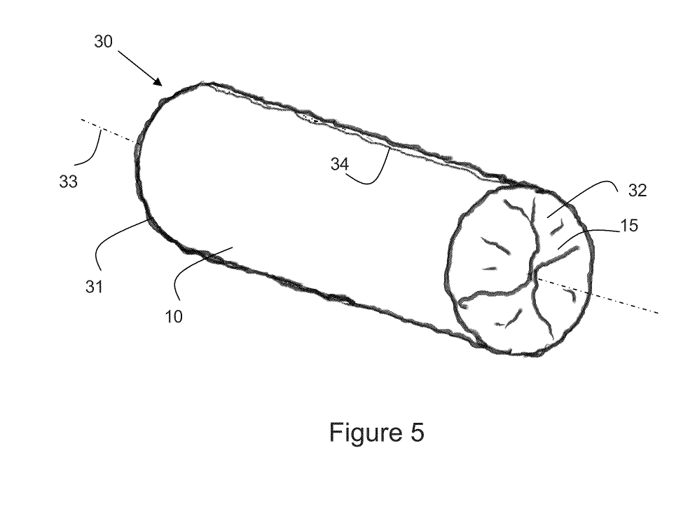

FIG. 4 presents another possible assembly or configuration of meat product 5 in which two opposite ends 15 of first wrapper 10 are folded toward central region 13 and may overlap a portion of central region 13, revealing portions of underside of wrapper 10. Folded ends 15 are disposed generally perpendicular to the first and second edges 11, 12. Folded ends 15 may overlap some or all of organ meat 20, which may be meats 22, 24. For some embodiments, the configuration of FIG. 4 represents an intermediate assembly for a first assembly 30 (FIG. 5) or a meat product 5.

Referring to FIG. 5, a first assembly 30 of wrapped meat product 5 comprises a first end 31, a second end 32, a longitudinal axis 33, and one or more longitudinal boundaries or seams 34 between adjacent or overlapping portions of first wrapper 10. The ends 31, 32 comprise, at least in part, portions of ends 15 of first wrapper 10. One or more portions of meat 20, which may be meats 22, 24, are disposed within wrapper 10 and may extend to or beyond ends 31, 32. FIGS. 2, 3, and 4 may describe one or more intermediate assemblies of the first assembly 30. In view of these three figures, it is apparent that the individual portions of meat 20, 22, 24 within first assembly 30 may remain in some aspect distinct or separated, at least in the raw assembly. First assembly 30 may comprise multiple, overlapping layers. First assembly 30 may comprise a multiply-folded or rolled configuration. Thus, first assembly 30 comprises organ meat 20 substantially wrapped in or surrounded by a first wrapper 10 wherein wrapper 10 may comprise one or more individual pieces. Wrapper 10 may visually occlude or partially occlude meat 20. First assembly 30 is a meat product in accordance with the teachings of this disclosure. More specifically, First assembly 30 is a wrapped meat product.

Returning to the example of FIG. 1, in at least one embodiment wrapped meat product 5, comprises first assembly 30 in combination with a second wrapper 40, which surrounds or covers at least a portion of first assembly 30. Second wrapper 40 comprises one or more portion of animal tissue or, equivalently, organ. In FIG. 1, second wrapper 40 comprises elongated, narrow portions of animal intestines wrapped lengthwise multiple instances around the circumference of first assembly 30 and extending in the direction of axis 33. The intestine or intestines of wrapper 40 form an overlapping, generally helical or spiral shape and may include one or more knots between adjacent portions or sections of intestine. Second wrapper 40 may act to hold first assembly 30 together by adding rigidity and/or tension. In at least one embodiment, instead of comprising multiply-wrapped elongate narrow portions, the second wrapper is configured as a wider, sheet-like material similar to first wrapper 10 shown in FIG. 2. Second wrapper 40 may be derived from one single animal, may be derived from two or more of a single type of animal, or may be derived from more than one type of animal.

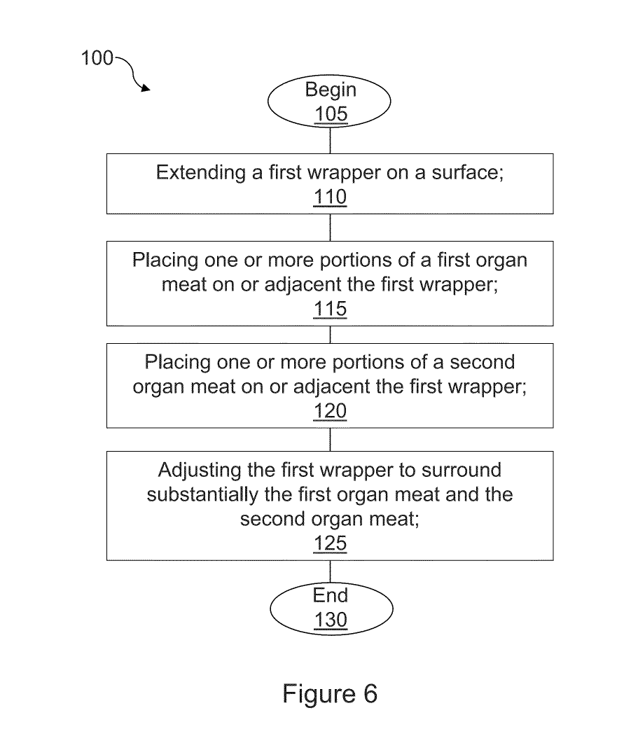

With consideration given to FIG. 2, an assembly process or production method for a wrapped meat product 5, 30 will be described. FIG. 6 presents a production method 100, which begins at step 105 and ends at step 130. Method step 110 includes extending a first wrapper 10 on a surface, which may be a substantially flat surface. In extending the wrapper, first wrapper 10 may be stretched, straightened, or adjusted lengthwise in one dimension, which may affect the other two dimensions. These other two dimensions may be called width and thickness. First wrapper 10 may be further stretched, straightened, or adjusted in a second or third dimension, which may affect the other dimensions. Even after being extended in one or more dimensions, wrapper 10 may have wrinkles, budges, protrusions, indentations, incisions, or other regions of non-uniformity. The example of FIG. 2 shows a first wrapper 10 as a single piece that spans two dimensions somewhat equally, but in another embodiment, wrapper 10 comprises multiple, separated pieces. Some pieces of wrapper 10 may be substantially longer in one dimension than in the other two dimensions.

Continuing with FIG. 6, method step 115 includes placing one or more portions of a first organ meat 22 on or adjacent the first wrapper 10. Method step 120 includes placing one or more portions of a second organ meat 24 on or adjacent the first wrapper 10. Method step 125 includes adjusting the first wrapper 10 to surround substantially the first organ meat 22 and the second organ meat 24. Referring to FIG. 2 or 3, an example of the adjusting process may proceed as follows: a section of inner wrapper 10, including first edge 11, is rolled (or, equivalently, lifted and folded) toward central region 13 and second edge 12, revealing a portion of the underside of wrapper 10. Continuing in the same direction, sections of inner wrapper 10 are rolled toward second edge 12. In this manner, first wrapper 10 is rolled around organ meat 20, for example organ meats 22, 24. The rolling or folding process continues until the first assembly 30 of meat product 5 is achieved as exemplified in FIG. 5. First assembly 30 is an embodiment of a meat product that may result from assembly method 100. In another example, if first wrapper 10 comprises multiple elongate pieces, the adjusting process may involve gathering and bundling multiple pieces of wrapper 10 and meat 20 together to form first assembly 30.

The production process for other embodiments may involve additional method steps in accordance with any of the procedures described or inferred by this disclosure. For example, at least one additional step may be performed to obtain the embodiment of wrapped meat product 5 shown in FIG. 1. This additional step includes surrounding at least a portion of the first wrapper 10 with a second or outer wrapper 40 comprising an animal organ. Equivalently stated, this additional step may surround at least a portion of first assembly 30 with an additional layer of animal tissue. For embodiments in which outer wrapper 40 comprises a length of animal intestines or another elongate organ, the intestines may be extended lengthwise and wound like a string around first assembly 30. Some portions of the intestine may overlap or intertwine other portions of the same intestine or a separate intestine.

For some embodiments, the production method for a meat product 5, 30 may proceed from the configuration of FIG. 2 or FIG. 3 to the configuration shown in FIG. 4 with one or more additional steps. To accomplish this result, the two opposite ends 15 of first wrapper 10 are adjusted by folding or rolling ends 15 toward the central region 13. The configuration shown in FIG. 4 may ultimately proceed to the first assembly 30 of FIG. 5 using one or more of the method steps previously described.

First assembly 30 or meat product 5 may be cooked or uncooked. One or more additional cooking or pickling method steps may be performed to adapt the, physical, chemical, or biological configuration of meat product 5, 30. For example, cooking may alter the size, the structural rigidity, the appearance, or the tactile quality of the meat product 5, 30. The one or more cooking or pickling steps may include coating, soaking, smoking, baking, frying, boiling, deep frying, and other mechanical, thermal, or chemical procedures. One or more of these steps may be performed on first organ meat 22 or the second organ meat 24, separately from the assembled meat product 5, 30. Even so, the same step or other cooking or pickling steps may be performed on the assembled meat product 5, 30, perhaps at a later stage in the production process. For embodiments that include fat as part of a wrapper 10, 40, the fat may melt during a cooking step and may act as a heat transfer fluid, augmenting the cooking process.

Meat product 5, 30 may be configures for use as an advertising tool or as a tool for evaluating or demonstrating the cooking conditions in a kitchen, for example. While the meat product 5, 30 may be edible and may be suited for human consumption, meat product 5, 30 may also be consumable by carnivorous animals. Off-specification or lower grades of meat product 5, 30 (those having a lower quality) may be particularly suited for consumption by carnivorous animals. Thus, the meat product described herein may be used for a variety of purposes.

While disclosed embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims.

What is claimed is:

1. A meat product taken from one or more animals, the meat product comprising:
a first wrapper comprising extendable animal organ;
at least a first organ meat; and
at least a second organ meat;
wherein the first wrapper substantially surrounds the first organ meat and the second organ meat.

2. The meat product of claim 1 wherein the first organ meat is heart.

3. The meat product of claim 1 wherein the second organ meat is liver.

4. The meat product of claim 1 wherein the first organ meat is heart, and the second organ meat is liver.

5. The meat product of claim 1 further comprising a second wrapper
wherein the second wrapper comprises extendable animal organ; and
wherein the second wrapper surrounds at least a portion of the first wrapper, the first organ meat, and the second organ meat.

6. The meat product of claim 5 wherein the first wrapper comprises animal stomach fat lining and the second wrapper comprises animal intestines.

7. The meat product of claim 1 comprising two portions of the first organ meat and one portion of the second organ meat.

8. The meat product of claim 1 wherein the first organ meat and the second organ meat are derived from a single animal.

9. The meat product of claim 1 wherein the first organ meat and the second organ meat are derived from more than one type of animal.

10. The meat product of claim 1 wherein at least one of the first organ meat and the second organ meat is sliced.

11. A meat product taken from one or more animals, the meat product comprising:
a first wrapper comprising stomach lining;
a first organ meat comprising heart;
a second organ meat comprising liver; and
a second wrapper comprising animal intestine;
wherein the first wrapper substantially surrounds the first organ meat and the second organ meat.
wherein the second wrapper surrounds at least a portion of the first wrapper.

12. The meat product of claim 11 comprising two portions of the first organ meat and one portion of the second organ meat.

13. The meat product of claim 11 derived from a single animal.

14. The meat product of claim 11 derived from a single type of animal.

15. The meat product of claim 11 derived from more than one type of animal.

16. A method for producing a meat product derived from animal, the method comprising:
Extending a first wrapper on a surface;
Placing one or more portions of a first organ meat on or adjacent the first wrapper;
Placing one or more portions of a second organ meat on or adjacent the first wrapper; and
Adjusting the first wrapper to surround substantially the first organ meat and the second organ meat.

17. The method of claim 16, wherein, adjusting the first wrapper involves rolling the first wrapper around the first and second organ meats.

18. The method of claim 16 further comprising the additional step of:
Folding two opposite edges of the first wrapper towards the central region of the first wrapper;

19. The method of claim 16 further comprising the additional step of:
Surrounding at least a portion of the first wrapper with a second wrapper comprising an animal organ.

20. The method of claim 16 further comprising at least one additional step, the at least one additional step comprising:
Cooking or pickling the meat product.
